(19) United States
(12) Patent Application Publication
(10) Pub. No.: US 2023/0286804 A1
(43) Pub. Date: Sep. 14, 2023

(54) DIRECT METHOD OF SYNTHESIS OF ZNO NWS/SWCNTS AND ZNO NWS/GRAPHENE HETEROSTRUCTURES

(71) Applicant: Saint Louis University, St. Louis, MO (US)

(72) Inventors: Irma Kuljanishvili, St. Louis, MO (US); Nicholas Schaper, St. Louis, MO (US)

(73) Assignee: Saint Louis University, St. Louis, MO (US)

(21) Appl. No.: 18/178,368

(22) Filed: Mar. 3, 2023

Related U.S. Application Data
(60) Provisional application No. 63/317,728, filed on Mar. 8, 2022.

(51) Int. Cl. C01B 32/168; C01B 32/194; C01B 32/162; C23C 2/04; C23C 2/34

(52) U.S. Cl. CPC C01B 32/168; C01B 32/194; C01B 32/162; C23C 2/04; C23C 2/34; C01B 2202/02; C01P 2002/82; C01P 2004/03

(57) ABSTRACT

The present disclosure provides methods of preparing heterostructures of a carbon-based structure and a metal oxide structure. Also provided are heterostructures formed via the methods described herein and devices comprising such heterostructures.

The present application claims the benefit of priority of U.S. Provisional Application No. 63/317,728, filed on Mar. 8, 2022, the entire contents of which are hereby incorporated by reference.

### BACKGROUND

### I. Field

The present disclosure relates generally to the field of nanomaterials. More particularly, it concerns methods of preparing heterostructures of a carbon-based structure and a metal oxide structure.

### II. Description of Related Art

Perpetually evolving technology requires novel materials and architecture designs to keep up with the growing, industry-driven demand towards miniaturization (Pitkethly, 2004). Nanoscale materials have been suggested as attractive alternatives to traditional materials because of their unique properties, which are consequential to their low dimensionality, that can be engineered to satisfy the needs of the next generation of applications. Specifically, 1D nanostructures have been intensely studied because they could be manufactured with targeted morphological characteristics and unique physical and electronic properties, mechanical strength, optical sensitivity, etc (Iijima & Ichihashi, 2003; Bethune et al., 1993). Nanomaterials play an essential role in developing life-saving therapeutics due to selective antibiotic (Ruddairaju et al., 2019; Li et al., 2012) and anti-cancer (Ruddairaju et al., 2019; Modugno et al., 2015; Pandurangan et al., 2016; Hanley et al., 2008; Rasmussen et al., 2010; Ahmed et al., 2012; Wang et al., 2017) properties, in addition to their potential for promising therapies for challenging pathological conditions (Keefer et al., 2008; Schwartz et al., 2006; Xie et al., 2014).

For instance, 1D carbon nanotubes (CNTs) have drawn much attention for their high aspect ratio, large surface area, and selective electrical properties making them ideal for scaffolds, functionalization with biomolecules, and electrode connections in devices cancer (Kordzadeh et al., 2019; Kocaman et al., 2020; Zhu et al., 2006; Zhao et al., 2017; Baughman et al., 2002). The electrical properties of single-wall CNTs (SWCNTs) properties can be selectively developed as either semiconducting or metallic, suggesting an ability to tailor them to targeted applications. Zinc oxide nanowires (ZnO NWs) are another 1D nanomaterial that has been proposed for applications in optoelectronics, photocatalysis, and charge collection and transport at heterojunctions due to their unique optical, electrical, and piezoelectric properties (Ok et al., 2010; Caglar et al., 2009; Xu et al., 2010; Bettini et al., 2015). ZnO is a wide bandgap semiconductor (˜3.37 eV) with high excitation energies (˜60 meV) that has also been shown to exhibit biocompatibility and low cytotoxicity (Shreshta et al., 2017; Xie et al., 2013), which makes it an excellent companion to 1D carbon nanotubes and even 2D graphene (Gr).

Many reported studies have investigated the unique properties of specific nanomaterials and have explored their myriad useful applications. However, fewer studies have focused on developing scalable methods for engineering heterostructures and interfaces with different nanomaterials to complement each other synergistically. Therefore, a need remains for such heterostructures and methods to prepare such heterostructures.

### SUMMARY

In some aspects, the present disclosure provides heterostructures of carbon-based structures and metal oxide structures. Also, described herein are methods of preparation of devices comprising such heterostructures.

In some aspects, the present disclosure provides methods of preparing a heterostructure of a carbon-based structure and a metal oxide structure comprising:
(A) exposing a carbon-based structure to an iron-based ink to obtain a heterostructure precursor composition; and
(B) transforming the heterostructure precursor composition in the presence of a metal oxide precursor into a heterostructure of a carbon-based structure and a metal oxide structure.

In some embodiments, the carbon-based structure is graphene. In other embodiments, the carbon-based structure is a carbon nanotube such as a single walled carbon nanotube.

In some embodiments, the metal oxide structure is a metal(II) oxide structure such as zinc oxide structure. In some embodiments, the iron-based ink comprises an iron salt in an iron solution. In some embodiments, the iron salt is an iron(III) salt such as iron(III) nitrate. In some embodiments, the iron salt is iron(III) nitrate nonahydrate.

In some embodiments, the iron-based ink further comprises a first solvent. In some embodiments, the first solvent is water such as deionized water. In some embodiments, the iron-based ink further comprises a second solvent such as dimethylformamide. In some embodiments, the iron-based ink further comprises a third solvent such as glycerol.

In some embodiments, the iron-based ink comprises a volume ratio of the iron solution to the first solvent from about 1:2 to about 4:1. In some embodiments, the volume ratio of the iron solution to the first solvent is from about 1:1 to about 3:1. In some embodiments, the volume ratio of the iron solution to the first solvent is about 2:1.

In some embodiments, the iron-based ink comprises a volume ratio of the iron solution to the second solvent from about 1:1 to about 6:1. In some embodiments, the volume ratio of the iron solution to the second solvent is from about 2:1 to about 4:1. In some embodiments, the volume ratio of the iron solution to the second solvent is about 3:1.

In some embodiments, the iron-based ink comprises a volume ratio of the iron solution to the third solvent from about 1:1 to about 10:1. In some embodiments, the volume ratio of the iron solution to the third solvent is from about 3:1 to about 8:1. In some embodiments, the volume ratio of the iron solution to the third solvent is about 6:1.

In some embodiments, the iron-based ink is deposited on a carbon-based structure in a pattern. In some embodiments, the pattern is a uniform pattern. In some embodiments, the iron-based ink is deposited using a dip-coating method. In other embodiments, the iron-based ink is deposited using a direct write method.

In some embodiments, the heterostructure precursor composition is transformed through chemical vapor deposition. In some embodiments, the transformation is done at an elevated temperature zone. In some embodiments, the elevated temperature zone is from about 500° C. to about 1,250° C. In some embodiments, the elevated temperature zone is from about 750° C. to about 1,000° C. such as about 930° C.

In some embodiments, the transformation comprises a second elevated temperature zone. In some embodiments, the second elevated temperature zone is from about 100° C. to about 500° C. In some embodiments, the second elevated temperature zone is from about 150° C. to about 350° C. In some embodiments, the second elevated temperature zone is from about 200° C. to about 300° C. such as about 270° C.

In some embodiments, the transformation occurs in a double tube system. In some embodiments, the double tube system comprises an inner tube and an outer tube wherein the outer tube is configured with a gas inlet. In some embodiments, the inner tube comprises an opening. In some embodiments, the inner tube comprises an opening at one end of the tube. In some embodiments, the inner tube is configured with the opening on the same side as the gas inlet.

In some embodiments, the transformation is done under an inert gas. In some embodiments, the inert gas is a noble gas such as argon. In some embodiments, the inner tube is a quartz tube. In some embodiments, the metal oxide precursor is located at the open end of the inner tube. In some embodiments, the metal oxide precursor is located from about 1 cm to about 15 cm to the open end of the inner tube. In some embodiments, the metal oxide precursor is located from about 2 cm to about 10 cm to the open end of the inner tube. In some embodiments, the metal oxide precursor is located from about 3 cm to about 5 cm to the open end of the inner tube.

In some embodiments, the transformation occurs via increasing temperature under an inert gas. In some embodiments, the transformation comprises purging with an inert gas. In some embodiments, the metal oxide precursor is located in the elevated temperature zone. In some embodiments, the heterostructure precursor composition is located in the second elevated temperature zone.

In some embodiments, the transformation comprises heating for a time period from about 15 minutes to about 300 minutes. In some embodiments, the time period is from about 30 minutes to about 210 minutes. In some embodiments, the time period is from about 60 minutes to about 150 minutes. In some embodiments, the time period is about 100 minutes. In some embodiments, the methods comprise purging with an inert gas at a purging flow rate from about 100 sccm to about 1,000 sccm. In some embodiments, the purging flow rate is from about 250 sccm to about 900 sccm. In some embodiments, the purging flow rate is from about 400 sccm to about 800 sccm. In some embodiments, the purging flow rate is about 600 sccm.

In some embodiments, the methods comprise a constant flow of an inert gas during the transformation at a rate from about 10 sccm to about 200 sccm. In some embodiments, the constant flow is from about 25 sccm to about 150 sscm. In some embodiments, the constant flow is about 50 sccm to about 100 sccm. In some embodiments, the constant flow is about 70 sccm.

In some embodiments, the methods comprise a cooling flow of an inert gas at a cooling flow rate of about 25 sccm to about 500 sccm. In some embodiments, the cooling flow rate is from about 50 sccm to about 400 sccm. In some embodiments, the cooling flow rate is from about 75 sccm to about 250 sccm. In some embodiments, the cooling flow rate is about 150 sccm.

In some embodiments, the methods comprise cooling the heterostructure to a cooled temperature from about 0° C. to about 50° C. In some embodiments, the cooled temperature is from about 10° C. to about 40° C. In some embodiments, the cooled temperature is from about 15° C. to about 35° C. In some embodiments, the cooled temperature is about 25° C.

In another aspect, the present disclosure provides heterostructures comprising a carbon-based structure and a metal oxide structure prepared according to the methods described herein.

In still another aspect, the present disclosure provides devices comprising a heterostructure described herein.

As used herein the specification, “a” or “an” may mean one or more. As used herein in the claim(s), when used in conjunction with the word “comprising”, the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

The term “chalcogen” or “chalcogenide” is an atom selected from either sulfur or selenium. The term chalcogenide generally references to the divalent ligand and chalcogen refers to the atom. Both of these terms though may be used interchangeably.

Throughout this application, the term “about” is used to indicate that a value includes the inherent variation of error for the device, the method being employed to determine the value, or the variation that exists among the study subjects.

The term “quaternary ammonium” is used to describe any tetra-substituted nitrogen atom which bears a positive charge. The term includes ammonium (NH₄) as well as other tetrasubstiuted nitrogen atoms such as tetramethylammonium (choline), tetraethylammonium, or tetraphenylammonium.

Other objects, features and advantages of the present disclosure will become apparent from the following detailed description. It should be understood, however, that the detailed description and the specific examples, while indicating preferred embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-C—A schematic illustration of the process to grow ZnO NWs/CNTs and ZnO NWs/Gr heterostructures on SiO2/Si substrates. A) CNTs growth including (i) dip-coating in catalytic CCFe ink precursor, (ii) CVD synthesis of CNTs, and (iii) representative CNTs sample. B) Graphene growth on (i) Cu foil via (ii) CVD and subsequent transfer of graphene from (iii) Cu substrate to (iv) SiO2/Si. C) Heterostructure growth beginning with (i) CNTs sample and (ii) graphene sample dip-coated in CCFe ink followed by (iii) CVD synthesis of ZnO NWs using dou-ble-tube method, resulting in (iv) ZnO NWs/CNTs and (v) ZnO NWs/Gr heterostructures.

FIGS. 2A-F—Characterization of as-grown 1D nanomaterials A) SEM image of CVD grown CNTs on SiO₂/Si substrate demonstrating uniformity and high density. B) Raman spectra of four representative locations from a CNTs sample highlighting radial breathing modes (RBM) and G-band regions of the spectra. C) AFM image of a few CNTs with and a line profile (inset). D) SEM image of ZnO NWs grown randomly on SiO₂/Si E) Raman spectra of 4 representative spots of D with characteristic E₂^{high} and E₂^{low} peaks of ZnO NWs. F) HRTEM image of ZnO NWs lattice structure showing lattice spacing ˜0.532 nm with SAED pattern (inset).

FIGS. 3A-3D—SEM and Raman data of the prepared heterostructures. A) SEM image of ZnO NWs/CNTs heterostructure at a boundary location, where the upper half of the SEM image shows the presence of both materials while the lower half only contains CNTs. Insets show zoomed-in regions of both the top and the bottom features. B, D) Raman spectra of ZnO NWs/CNTs and ZnO NWs/Gr heterostructures spanning both the ZnO NWs characteristic region (90 cm⁻¹ to 460 cm⁻¹) and the CNTs/Gr characteristic region (1100 cm⁻¹ to 3000 cm⁻¹). The two spots correlate with the spots shown in A and in C, respectively. C) SEM image of ZnO NWs/Gr heterostructure at boundary location, where the top right corner shows only ZnO NWs grown on SiO₂/Si, while in the bottom left corner shows ZnO NWs grown on a multi-layer of graphene.

FIG. 4—Raman Characterization of Graphene. Raman spectroscopic data of Graphene on Cu (red) before transfer and graphene on SiO₂/Si (black) after transfer.

FIGS. 5A-D—EDS data and PL spectroscopy. A-C) EDS analysis demonstrated expected Zn, O, and Si presence in the prepared ZnO NWs/Gr, ZnO NWs/CNTs heterostructures, and ZnO NWs reference samples, respectively. The insets show SEM micrographs for each respective sample where EDS data was collected. D) PL spectra of all three prepared sample types had observed peak maxima of 3.313 eV.

FIGS. 6A-C—XPS analyses of ZnO NWs, ZnO NWs/CNTs, and ZnO NWs/Gr heterostructure. A-C) Binding energy positions of Zn2p, O1s, and CIs for ZnO NWs (black), ZnO NWs/CNTs (red), and ZnO NWs/Gr (blue) heterostructures, respectively. Gaussian fits are applied to O1s curves in B, showing three-peak deconvolution in each sample. Survey data from each sample can be found in FIG. 7A.

FIGS. 7A-B—Additional XPS Spectra. A) Survey spectra for ZnO NWs/Gr (blue) and ZnO NWs/CNTs (red) heterostructures and ZnO NWs reference. B) O1s region for ZnO NWs/CNTs heterostructure with the 532.9 eV peak subtracted, revealing a convolved peak consistent with the one seen in FIG. 6B for ZnO NWs reference sample and ZnO NWs/Gr heterostructure.

FIGS. 8A-G—Direct-write patterning of ZnO NWs/CNTs heterostructure. A) SEM image of etched SiO₂/Si substrate with CNTs grown uniformly. B) Schematic of patterning process used to fill selected features with CCFe catalytic ink prior to ZnO NWs growth. C) Optical image of filled star-shaped feature with as-grown CNTs present prior to ZnO NWs growth. D) SEM micrograph etched feature indicated in D following ZnO NWs growth. E, F) Raman mapping of star feature in D with the CNTs G-band mapped at 1589 cm-1 E. and the E₂^{high} peak mapped at 98.8 cm-1 F. G) representative Raman spectra taken at corresponding spots indicated in D.

FIGS. 9A-I—Controlled synthesis of ZnO NW on etched-in SiO2/Si substrates. To demonstrate the selectivity of ZnO NWs growth, CCFe catalytic ink was directly deposited A) into selected areas of SiO₂/Si. ZnO NWs were then grown primarily in these premeditated locations. SEM images of features before (D, G) and after (E, H) ZnO NWs growth provided visual confirmation of growth. Raman spectroscopy (C) and Raman intensity mapping (F, I) centered at E₂^{high} provided a qualitative characterization of ZnO NWs inside of these geometric features.

### DESCRIPTION OF ILLUSTRATIVE EMBODIMENTS

Provided herein are heterostructures of a carbon-based structure and a metal oxide structures which may be useful to engineer architectures based on the properties of the component materials. In other aspects, efficient and scalable methods for the preparation of such heterostructures are provided herein. The instant application additionally provides devices comprising said heterostructures.

### I. HETEROSTRUCTURES

The flexibility, optical transparency, and electrical properties of 2D atomically thin graphene have generated interest in its use in photonics, transistors, and applications in energy production and storage (Zhang et al., 2013), making it a valuable material to investigate for devices.

Preparing interfaces between two or more nanomaterials provide opportunities to harness properties inherent to each material and synergistically combine them to create a broader range of applications. Hybrids structures assembled from CNTs and ZnO NWs (Ok et al., 2010; Singh et al., 2013) and graphene and ZnO NWs (Song et al., 2014; Anand et al., 2014; Panth et al., 2020; Nourmohammadi et al., 2014; Fu et al., 2012; Lee et al., 2009; Alameri et al., 2018; Alameri et al., 2017) have been examined and showed promising results of the enhancement of their native properties, when two materials are integrally combined. Investigations into hybrid systems containing CNTs and zinc oxide have utilized ZnO in various forms, including ZnO nanoparticles (NPs) beaded on CNTs (Zhu et al., 2006), ZnO NPs dispersed in scaffolds containing CNTs (Shreshta et al., 2017), and ZnO nanorods grown on bundles of buckled multi-walled carbon nanotubes (MWCNTs) (Singh et al., 2013). These studies have confirmed an enhancement to electrical properties when CNTs and ZnO exist in a hybrid form. The heterostructure formed between graphene and ZnO NWs has also been a motivation for researchers. Previous studies have reported ZnO NWs grown on graphene via a solution-based hydrothermal method and have shown that graphene can be beneficial to the growth of ZnO NWs and can enhance their field electron emission (Song et al., 2014). At the same time, hybrid systems made of Gr/ZnO or Graphene Oxide/ZnO structures have also been shown to operate as hydrogen sensors (Anand et al., 2014), strain sensors (Panth et al., 2020), and for the photoinactivation of bacteria (Nourmohammadi et al., 2014) effectively. Hybrid materials in these studies were formed through hydrothermal growth or proximity placement methods, and found that the piezoelectric, photoactive, and antibacterial properties of the 1D ZnO NWs combine well with the conductive, transparent 2D support structure of the graphene sheet. This makes hybrid ZnO NWs/Gr structures a promising nanomaterial for use in sensors (Anand et al., 2014; Panth et al., 2020), photovoltaic cells (Fu et al., 2012), and energy storage (Lee et al., 2009).

MWCNTs have been successfully implemented in hybrid ZnO NWs/CNTs systems. For example, in the study by Ok et al., ZnO NWs were produced on the surface of vertically aligned MWCNT forests, exhibiting enhanced electrical responses while remaining mechanically robust (Ok et al., 2010). The author's method consisted of growing a vertically aligned MWCNT forest via chemical vapor deposition (CVD) at 775° C. followed immediately by the growth of ZnO NWs on the outer surfaces of these tube clusters in a subsequent thermal evaporative method at ˜420° C. In their process, the entire MWCNTs forest was encapsulated in ZnO NWs, creating a structure with a MWCNT core and ZnO NWs outer shell. Another group has produced horizontally aligned buckled MWCNTs forests through pyrolysis followed by CVD growth of ZnO NWs on the sidewalls of these structures. They have shown the material to have Schottky-like behavior and p-type conductivity, which allows it to be used in applications of ultraviolet detectors, high current p-type field-effect transistors, and other multifunctional devices (Singh et al., 2013). These studies confirmed the heterostructures possess enhanced electrical properties. However, methodologies combining low-temperature ZnO NWs synthesis, such as hydrothermal growth (70-200° C.), require extended growth periods (12-48 hr) and do not produce the high-quality crystal structures capable through CVD (Alameri et al., 2017; Geng et al., 2004). Additionally, the use of MWCNT bundles limits one's control over the electrical properties of the material, unlike SWCNTs, which allow greater flexibility for being tai-lored to either semiconductive or metallic performance.

There has also been considerable interest in developing hybrid structures of graphene and ZnO in various forms. Researchers have been successful in developing methods such as transferring as-grown ZnO NWs onto graphene (Fu et al., 2012), growing ZnO nanorods directly on graphene via a hydrothermal process (Song et al., 2014; Lee et al., 2009), or even electrophoretic deposition of graphene oxide within ZnO NWs (Nourmohammadi et al., 2014). Although effective in creating heterostructures, and some even at lower temperatures, these methods did not produce high-quality materials and are time-consuming (involve many more steps), unlike those observed with CVD.

In this study we demonstrate a selective, scalable two-step CVD method of growing high-quality heterostructure interfaces of ZnO NWs/SWCNTs and ZnO NWs/Gr. Our bottom-up synthesis approach produces nanomaterials with highly organized crystal structures. Here we have developed a method of producing ZnO NWs uniformly on a flat network of SWCNTs in a two-step CVD process using our universal catalytic Fe ink to catalyze both materials. This creates an interface between the semiconducting ZnO NWs and the underlying network of semiconducting CNTs, which opens up the future possibilities to engineer more complex architectures based on the properties of both materials given the ability to control electrical properties of the base layer CNTs by adjusting the expression of SWCNTs characteristics.

Additionally, we have realized a two-step CVD procedure whereby ZnO NWs are grown directly on top of CVD-grown graphene. Dense ZnO NW forests have been grown on the surface of graphene, covering the entire area of the conductive 2D sheet with the semi-conducting ZnO NWs. This process is efficient and scalable, producing high-quality ZnO NWs/Gr interface with desirable morphologies exploiting unique surface characteristics or graphene; its atomic flatness and significant hydrophobicity, thus enabling to tune resulting morphology of the ZnO NWs/Gr system.

Finally, a catalytic ink precursor allows for selective heterostructure growth in predeter-mined areas demonstrated with our novel direct-write patterning (DWP) approach. The ability to create intimate interfaces between these unique materials provides platforms for generating an opportunity for the two or more materials to complement one another's physical and electrical properties or mechanical and thermal performance.

In some aspects, the present disclosure relates heterostructures comprising a carbon-based structure and a metal oxide structure and methods for preparation of such heterostructures. Devices comprising such heterostructures are also contemplated. The methods for preparing the heterostructures disclosed in the present application comprise two steps: A: exposing carbon-based structures to iron-based inks to obtain heterostructure precursor compositions, and B: transforming said heterostructure precursor compositions in the presence of metal oxide precursors into heterostructures of carbon-based structures and metal oxide structures. The carbon-based structures may be graphene or carbon nanotubes. The carbon nanotubes may, for example, be single-walled carbon nanotubes. The metal oxide structure may be a metal (II) oxide structure such as a zinc oxide, a titanium oxide, a vanadium oxide, or a tungsten oxide. A particular metal oxide structure that is contemplated is zinc oxide structure. The methods disclosed herein may comprise cooling the heterostructure. The heterostructure may be cooled to a temperature between about 0° C. to about 1,000° C. The temperature of the elevated temperature zone 700° C., 750° C., 800° C., 850° C., 900° C., 950° C., to about 1000° C.

The iron-based ink may be deposited on the carbon-based structure in a pattern. These patterns may include an array of dots, an array of ribbons or lines, or an array of zig-zag or another meandering shaped lines. The iron-based ink may be deposited using a dip-coating method. Alternatively, it is contemplated in the current disclosure that the iron-based ink may be deposited using a direct-write method.

### II. INK COMPOSITIONS

A. Iron-Based Ink

In some aspects, the present methods of the present disclosure comprise the use of an iron-based ink. The iron-based ink may comprise an iron salt. These iron salts may be an iron (II) salt or an iron (III) salt, a nonlimiting example of which is iron(III) nitrate. A specific iron salt which is contemplated is iron(III) nitrate nonahydrate. In some embodiments, these iron-based inks may comprise a first solvent. The iron-based inks may further comprise a second solvent. The iron-based inks are also contemplated to comprise a third solvent.

B. Solvents

In some aspects, the present disclosure relates to the use of iron-based ink compositions which further comprise one or more solvents. The methods disclosed herein may comprise a first solvent. In some embodiments, the methods disclosed herein comprise a second solvent. In further embodiments, the methods disclosed herein comprise a third solvent. The preferred solvents do not react with the surface or the materials deposited on the surface. Additionally, the solvents used in the ink composition may be substantially free of blocking agents such as a polymer. In some embodiments, the ink compositions are formulated in water. The water may be filtered such that the solvent does not contain any particles which are greater than 0.2 μm in size. In some embodiments, the water is deionized. In some embodiments, the ink compositions are formulated in dimethylformamide. In other embodiments, the ink compositions are formulated in glycerol.

The iron salt of the iron-based ink may be present in different volume ratios with regard to the at least one solvent. In some aspects, the volume ratio of the iron salt to a first solvent is from about 1:2 to about 4:1. In some embodiments, the volume ratio of the iron salt to a first solvent may be about 1:1, about 2:1, or about 3:1. In certain embodiments, the volume ratio of the iron salt to a first solvent is about 2:1. Also contemplated in the present methods are volume ratios of the iron salt to a second solvent that may be from about 1:1 to about 6:1. The methods presented herein may have a volume ratio of iron salt to second solvent that are about 2:1, about 3:1, or about 4:1. In certain embodiments, the volume ratio of the iron salt to a second solvent is about 3:1. Also contemplated in the present methods are volume ratios of the iron salt to a third solvent that may be from about 1:1 to about 10:1 or from about 3:1 to about 8:1. The methods presented herein may have a volume ratio of iron salt to second solvent that are about 3:1, about 4:1, about 5:1, about 6:1, about 7:1, or about 8:1. In certain embodiments, the volume ratio of the iron salt to a second solvent is about 6:1.

### III. TRANSFORMATION OF PRECURSORS INTO HETEROSTRUCTURES

In some aspects of the methods disclosed herein, heterostructure precursor compositions are transformed in the presence of metal oxide precursors into heterostructures of carbon-based structures and metal oxide structures. In some embodiments, this transformation occurs through chemical vapor deposition.

In some embodiments, the transformation comprises an elevated temperature zone. It is contemplated that the elevated temperature zone may be from about 500° C. to about 1,250° C. In some embodiments, the elevated temperature zone is from 700° C. to about 1,000° C. The temperature of the elevated temperature zone 700° C., 750° C., 800° C., 850° C., 900° C., 950° C., to about 1000° C. In certain embodiments of the presently disclosed methods, the elevated temperature zone is about 930° C. The metal oxide precursor may be located in the elevated temperature zone. The transformation disclosed in the methods of the present application may in some embodiments comprise a second elevated temperature zone. It is contemplated in the that the second elevated temperature zone may be from about 100° C. to about 500° C. The second elevated temperature zone may be from 150° C. to about 350° C. or more particularly from about 200° C. to about 300° C. The second elevated temperature zone may be about 200° C., about 210° C., about 220° C., about 230° C., about 240° C., about 250° C., about 260° C., about 270° C., about 280° C., about 290° C., or about 300° C. In certain embodiments, the second elevated temperature zone is about 270° C. The heterostructure precursor composition may be located in a second elevated temperature zone.

In some embodiments, methods disclosed in the present application contemplate the transformation occurring in a double tube system. In some embodiments, the double tube system may comprise an inner tube and an outer tube, wherein the outer tube is configured with a gas inlet. In some embodiments, the inner tube is a quartz tube. The present methods further contemplate an inner tube that comprises an opening. An opening on the inner tube may be on the same side as a gas inlet present on the outer tube. In some embodiments, the methods disclosed herein comprise a transformation wherein the metal oxide precursor is located at the open end of the inner tube. In some embodiments, the metal oxide precursor may be located from about 1 cm to about 15 cm from the open end of the inner tube. In further embodiments, the metal oxide precursor may be located from about 2 cm to about 10 cm from the open end of the inner tube. In still further embodiments, the metal oxide precursor may be located from about 3 cm to about 5 cm from the open end of the inner tube. In even further embodiments, the metal oxide precursor may be 3 cm, 4 cm, or 5 cm from the open end of the inner tube.

The transformation disclosed in the methods of the present application may be carried out under inert gas. The transformation may comprise purging with an inert gas. The transformation may involve purging with an inert gas at a purging flow rate from about 100 sccm to about 1,000 sccm. The purging flow rate may be from about 250 sccm to about 900 sccm or more particularly from about 400 sccm to about 800 sccm. The purging flow rate may be about 400 sccm, about 450 sccm, about 500 sccm, about 550 sccm, about 600 sccm, about 650 sccm, about 700 sccm, about 750 sccm, or about 800 sccm. In certain embodiments of the presently disclosed methods, the purging flow rate is about 600 sccm.

In some embodiments of the present disclosure, the method may comprise a constant flow of an inert gas during the transformation. The rate of the constant flow of inert gas during the transformation may be from about 10 to about 200 sscm. The rate of constant flow of inert gas may be about 10 sccm, about 20 sccm, about 30 sccm, about 40 sccm, about 50 sccm, about 60 sccm, about 70 sccm, about 80 sccm, about 90 sccm, about 100 sccm, about 110 sccm, about 120 sccm, about 130 sccm, about 140 sccm, about 150 sccm, about 160 sccm, about 170 sccm, about 180 sccm, about 190 sccm, or about 200 sccm. In certain embodiments of the presently disclosed methods, the rate of constant flow of inert gas during the transformation is about 70 sccm.

In some embodiments of the present disclosure, the methods may comprise a cooling flow of an inert gas. The flow rate of the cooling flow of an inert gas may be from about 25 sccm to about 500 sccm. More particularly, the flow rate of the cooling flow of an inert gas may be from about 50 sccm to about 400 sccm or about 75 sccm to about 250 sccm. The rate of flow of the cooling flow of an inert gas may be about 75 sccm, about 100 sccm, about 125 sccm, about 150 sccm, about 175 sccm, about 200 sccm, about 225 sccm, or about 250 sccm. In certain embodiments of the presently disclosed methods, the rate of cooling flow of inert gas is about 150 sccm.

The inert gas as disclosed in the present methods may be a noble gas. Some specific inert gases which may be used include helium, neon, argon, krypton, xenon, or radon. In certain embodiments, the transformation is done under argon.

The transformation as disclosed in the present application may occur via increasing temperature under an inert gas. In some embodiments, the methods disclosed in the present application consider a transformation comprising heating for a time period from about 15 minutes to about 300 minutes, more particularly for a time period from about 30 minutes to about 210 minutes. The time period may be about 30 minutes, about 40 minutes, about 50 minutes, about 60 minutes, about 70 minutes, about 80 minutes, about 90 minutes, about 100 minutes, about 110 minutes, about 120 minutes, about 130 minutes, about 140 minutes, about 150 minutes, about 160 minutes, about 170 minutes, about 180 minutes, about 190 minutes, about 200 minutes, or about 210 minutes. In certain embodiments of the presently disclosed methods, the transformation comprises heating for about 100 minutes.

### IV. EXAMPLES

The following examples are included to demonstrate preferred embodiments of the disclosure. It should be appreciated by those of skill in the art that the techniques disclosed in the examples which follow represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Example 1—Materials and Methods

a. Materials

Iron (III) nitride nonahydrate (Fe(NO₃)₃·9H₂O), (Sigma-Aldrich, 99.99% purity), N,N-dimethylformamide (Sigma-Aldrich, ≥99% purity), and glycerol (Sigma-Aldrich, ≥99.0% purity) were used as solvents in the custom composite iron-based (CCFe) ink. Graphite (Alfa Aesar, 99.999% purity) was mixed with equal parts (35 mg each) of ZnO powder (Alfa Aesar, 99.999% purity) and used as ZnO/C source precursors during the growth process. Copper (Cu) foil (Alfa Aesar, 99.8% purity and thickness of 0.025 mm) was used as the catalyzing substrate for Gr synthesis. Si/SiO₂ wafers (University Wafer, South Boston, Mass., P/B, (100), Resistivity: 1-5 mf-cm) with a 285 nm wet thermal oxide layer were cut into pieces measuring 5×5 mm and used as growth substrates in this study.

b. Methods

i Direct-Write Patterning (DWP) Method

DWP was utilized for delivering catalytic ink directly into etched-in features. This was performed with a custom-built instrument equipped with three piezo-driven stages, which aid precise XYZ manipulation/positioning (Alameri et al., 2017). Additionally, atomic force microscopy (AFM) cantilevers outfitted with multiple tips (12 pens), and custom ink-reservoirs were utilized during patterning (cantilevers and ink-reservoirs purchased from Advanced Creative Solutions Technology LLC, Des Plaines, Iowa). A stock “master solution” (MS) was created by dissolving 2.8 mg Iron (III) nitride nonahydrate in 12 ml of deionized (DI) water (18.2 M-Q cm) and sonicated for 10 min. To prepare CCFe ink, the master stock solution was further diluted in solvents such as N,N-dimethylformamide (DMF) and Glycerol at parts per volume ratio, as follows 6MS: 3DI: 2DMF: 1Glycerol. Mixed CCFe precursor ink was used throughout the study either for dip-coating and direct-write patterning (Kuljanishvili et al., 2009).

ii CVD Synthesis of CNTs

A catalytic CVD method modified from previously established protocols (Kuljanishvili et al., 2009). was modified and optimized to grow dense, randomly oriented SWCNT networks. The CVD system equipped with a three-zone furnace (Thermo Scientific Lindberg/Blue M, Waltham, Mass.), and a quartz tube (6 ft L, 22 mm ID, 25 mm OD) (Technical Glass Products, Painesville, Ohio), and a digital mass flow controller (Sierra Instrument, Monterey, Calif.) was used in all experiments. Substrates were cleaned in DI water, acetone, isopropanol via 10 min sonication. (BRANSON, Model #2800, 40 kHz). They were further processed in a UV ozone system for 2 min (Novascan PSD Pro Series Digital UV Ozone System, Boone, Iowa) to increase hydrophilicity immediately prior to coating in CCFe ink (see Materials section). Several SiO₂/Si samples dip-coated in CCFe ink were placed in a 5-inch quartz boat (Technical Glass Products). CVD growth of CNTs was done under the following conditions: first, the system was purged with ultra-high purity Ar (500 sccm) for 10 min at 25° C. The temperature was then increased to 365° C. under Ar/H₂ (300/150 sccm), and samples were preconditioned for 65 min. H₂ gas (500 sccm) alone was run for 10 min at 900° C. before growth. A mix of H₂/Ar/CH₄ (140/60/900 sccm) was used during the growth for 17-20 min. The furnace was then cooled under the protection of H₂/Ar (100/200 sccm).

iii CVD Synthesis of ZnO NWs

For CVD growth of ZnO NWs, an additional, smaller quartz tube with one end closed (600 mm L, 16 mm ID, 18 mm OD) (Technical Glass Products, Painesville, Ohio) contained the ZnO/C precursor and samples. The precursor was placed in a small quartz boat (20 mm L, 10 mm W, 8 mm H) (Technical Glass Products, Painesville, Ohio) at the closed end of the quartz tube in a ratio of 35 mg: 35 mg (m/m) graphite:ZnO. Samples were placed near the open end of the tube, approximately 3-5 cm from the opening. The small diameter quartz tube was placed inside of the CVD with the open end facing the gas inlet and positioned such that the ZnO/C precursor is located within the 930° C. zone of the furnace, while the samples are located within the 270° C. zone. The CVD growth procedure for ZnO NWs was modified from previously established CVD protocols (Alameri et al., 2017; Kuljanishvili et al., 2009). It involved purging with Ar (600 sccm) at 25° C., increasing the temperature under Ar (70 sccm) to 930° C. at which point ZnO NWs growth occurs over 100 min in an Ar (150 sccm) atmosphere. The furnace was cooled under the protection of Ar (150 sccm).

iv CVD Synthesis of Graphene

Modified CVD method was employed to grow a few layers of graphene from a previously established procedure (Dong et al., 2016). Pieces of Cu foils were cleaned, annealed in a hydrogen rich environment at (550° C., 60 min), and used as substrates. Prior to growth, the system was purged with Argon/Hydrogen (Ar/H₂) gases in a ratio of 450/50 sccm, respectively. Methane was used as the carbon source (20 sccm) to grow graphene sheets atop the prepared Cu-foil substrates during the growth. High CVD temperatures (970° C.) were utilized to achieve a uniform and high-quality product. After 10 min growth time, the CVD furnace cooled naturally under Ar/H₂ protection. A commonly used wet transfer method was employed to transfer graphene to a pre-cleaned SiO₂/Si substrate. More details can be found in the section that follows.

V Graphene Transfer from Copper Foil to SiO2/Si Substrate

Cu/graphene samples were cut to size and secured with double sided tape to a flat surface. A spin coater (WS-650Mz-23NPPB, Laurell Technologies Corporation, North Wales, Pa.) was used to apply Poly(methyl methacrylate) (PMMA), fully covering the prepared graphene samples. The spin coater was run at a rate of 1000 rpm for 10 sec then 4900 rpm for 40 sec. The PMMA/Graphene/Cu was peeled from the tape with a tweezers and flattened. The sample was then treated in a UV ozone system (Novascan PSD Pro Series Digital UV Ozone System, Boone, Iowa) with Cu side up for 10 min. 45 g of Iron(III) Chloride (Sigma Aldrich, 97% purity) was diluted in 120 mL of DI water (0.45 mM, resistivity 18.2 MΩ-cm) to etch the copper from the sample. In a petri dish, samples were floated on this solution with the Cu side facing down. The petri dish was heated to 100° C. and left until all the Cu was fully etched away (˜15-30 min). A glass spoon (13 cm L, 2.5 cm bowl diameter) (Technical Glass Products, Painesville, Ohio) was used to transfer samples from the FeCl solution through several petri dishes of DI water for faster dilution. Samples were then cleaned with HCl in a 1:1 solution of DI water:HCl. Samples remained in the HCl solution for 5 min and then diluted in a similar fashion as described above. In the final rinse, the petri dishes were heated to 100° C. for 15 min, and then left to cool down naturally. Once cooled to room temperature, the samples were extracted from the DI water solution directly onto a clean SiO₂/Si substrate, placed in a warm acetone bath for 1 hr, then annealed in a furnace at 450° C. under Ar/H₂ (400/200 sccm) protection. Samples were stored in a dry location until ready to be used.

vi Lithography-Reactive Ion Etching (Substrate Preparation)

Samples with star- and square-shape etched-in geometrical features/trenches used in this study were prepared by lithographic method using laser writer (MLA150 Heidelberg) followed by reactive ion etching (RIE). Briefly: 4″ Si oxidized wafers (University Wafer, South Boston, Mass., P/B, (100), Resistivity: 1-5 mΩ·cm, 285 nm wet thermal oxide), were treated with hexamethyldisilizane (HMDS) at 150° C., in a Yield Engineering System (YES-58TA) oven, to improve adhesion after cooling, the wafers were spin-coated with optical resist S1805 of ˜500 nm (Laurel, model WS-400A(B)-6NPP/LITE/(8K)). The laser exposure was performed at a wavelength of 405 nm, dose 65 mJ/cm², and subsequently developed. The oxide layer was then etched in a PlasmaLab 100 Oxford system, at 20° C., back cooling electrode He 5 Torr, pressure 20 mT, RF power 120 W, gas mixture SF₆ and O₂ with a flow of 35 sccm (standard cubic centimeters per minute) and 1 sccm respectively at the etching rate of 25 nm/min. After etching, and resist removal (with remover 1165 at 70° C. for 1 hr), sample were examined with Optical microscope Olympus MX-61. A surface profiler (Tencor Instruments Alpha Step 500) and a Filmetrics F40-UV were used for sample metrology.

c. Measurements and Characterization Tools

In this study, various characterization methods were used to characterize samples, including scanning electron microscope (SEM; FEI Inspect F50, Lausanne, Switzerland), atomic force microscope (AFM; Park NX 10, Suwon, South Korea), Raman spectroscopy (Renishaw, InVia, 532 nm, 100× objective, Wotton-under-Edge, Gloucestershire, England), X-ray photoelectron spectroscopy (XPS; PHI 5000 Versa Probe-II, Lafayette, La.), energy dispersive spectroscopy (EDS; JEOL JSM-7001 LVF Field Emission SEM), photolumines-cent spectroscopy (PL; Nanolog spectrofluorometer, Horiba, Kyoto-shi, Japan), high-resolution transmission electron microscopy (HRTEM; JEOL JEM-2000 FX TEM, 200 kV, Peabody, Mass.).

### Example 2—Results and Discussion

The methods disclosed herein allow for a streamlined direct two-step CVD process to grow either ZnO NWs/CNTs or ZnO NWs/Gr heterostructures in a controlled manner; with the integrity of an individual nanomaterial is maintained in each heterostructured assembly.

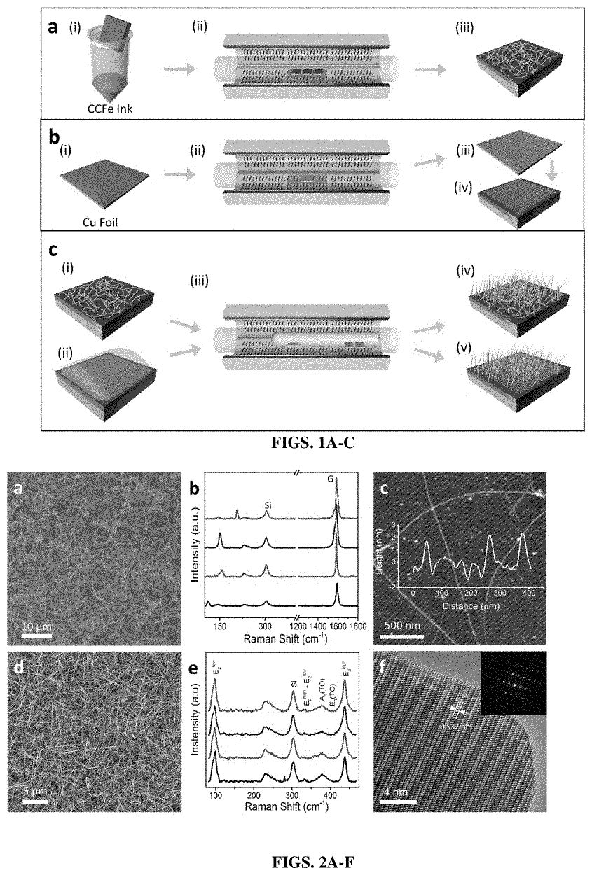

A schematic of the flow process and the sequential steps to produce high-quality heterostructures of ZnO NWs/CNTs and ZnO NWs/Gr is depicted in FIG. 1. First, a dense network of horizontal oriented CNTs (FIG. 1A(i-iii)) or few-layer graphene (FIG. 1B(i-iv)) were prepared via CVD as shown. While CNTs networks were prepared on SiO₂/Si substrate using CCFe ink as a catalyst, graphene was prepared on Cu foil, which, without being bound by theory, also acted as catalysts.

a. Experimental Design

Universal CCFe molecular ink deposited on substrate catalyzed both CNTs and subsequently ZnO NWs. CCFe ink was effectively used for either dip-coating samples or selectively patterning regions of interest prior to growth, enabling a much more simplified and universal method for producing a desirable heterostructured interface. The CCFe ink is preferable to water-based inks as the low vapor pressure of DMF allows a better wetting of the substrate surface (Kuljanishvili et al., 2009). Likewise, this ink did not exhibit humidity-dependent constraints during DWP, which were commonly experienced with water-based inks. After CNTs growth, the samples did not require recoating with catalysts for ZnO NWs growth since our CCFe ink effectively catalyzes both materials, CNTs and ZnO NWs, respectively. CNTs were synthesized prior to ZnO NWs because the reduction process under H₂ during CNTs synthesis could etch the ZnO NWs, thereby introducing impurities and sometimes detrimental vacancies, which would compromise the ZnO NWs (Ok et al., 2010). Graphene, once it is grown on Cu foil, could be transferred to a variety of substrates, both rigid and flexible, providing great versatility in applications. To produce ZnO NWs/Gr heterostructures, graphene must be coated with CCFe prior to ZnO NWs growth to serve as a catalyst. The graphene surface is not modified via UV ozone before dip-coating as, without being bound by theory, this could damage the graphene or introduce defects.

The growth of both ZnO NWs/CNTs (FIG. 1C(iv)) and ZnO NWs/Gr (FIG. 1C(v)) heterostructures utilized the same unique (customized) ZnO NWs CVD recipe, modified from previous studies (Alameri et al., 2017; Geng et al., 2004). The ZnO NWs growth process consisted of a double-tube arrangement where the open end of the inner tube faced the gas inlet. In the method disclosed herein, the inner tube allowed Zn²⁺ and O₂ vapors to achieve regional saturation at the open end of the tube where the samples were placed. Unlike some studies, the method disclosed herein does not require low-pressures or furnace temperatures greater than 1000° C. and is therefore a more simplified and time-efficient protocol. Substrate and source temperatures were important factors in controlling ZnO NWs morphology, and here it was achieved through three individually controlled zones of the CVD furnace (Wongchoosuk et al., 2011). Without being bound by theory, the versatility of the CCFe catalytic molecular ink allowed the ink to be patterned in a highly selective manner, which provided utility in applications requiring microscale or nanoscale precision. See the preceding Materials and Methods section for more details about DWP.

b. Growth and Characterization of CNTs and ZnO NWs

The methods disclosed herein for growing heterostructured interfaces begin with the synthesis and characterization of the individual materials. To quantify changes in quality or morphology of the nanomaterials, they were characterized prior to and the following incorporation into the heterostructures. CNTs grown for this study were optimized in density and uniformity FIG. 2A over the entire sample (SiO₂/Si surface). While CNTs grew horizontally, as a monolayer, ZnO NWs tended to grow vertically in a forest-like arrangement (FIG. 2D) with high density and relatively random organization. A representative (AFM) image of CNTs grown on SiO₂/Si (FIG. 2C) shows the diameters of CNTs ranged from 1.7 nm to 2.4 nm, which, without being bound by any theory, indicated the CNTs grown are likely single-walled.

Resonant Raman spectroscopy was employed to evaluate the quality of as-grown CNTs to determine their physical nature and electronic structure. The Raman characteristic spectrum for CNTs at four representative locations of the sample in FIGS. 2A-C are shown in FIG. 2B-D, respectively. This spectrum spanned the range of Raman shifts specific to radial breathing modes (RBMs) (˜100-350 cm⁻¹), D-band (˜1350 cm⁻¹), and G-band (˜1580 cm⁻¹). Without being bound by theory, diameters of the CNTs were confirmed to range from 0.7 to 2.3 nm based on analyses of the RBM values, supporting observed AFM results (Jorio et al., 2003; Dreselhaus et al., 2010). Without being bound by theory, a narrow, intense G-band at 1583 cm⁻¹, full width at half-maximum (FWHM) ˜23.2 cm⁻¹, and a high-quality factor (intensity ratio IG/ID>100) in FIG. 2B indicated that the produced CNTs are of very high quality with minute amount of defects. A number of as-grown CNTs samples were measured (usually, an array of 25 spots tested per sample), and with examination of G-band peak, (its line shape and average FWHM), it was determined that this CVD grown process renders CNTs predominantly semiconducting.

ZnO NWs exhibit a characteristic Raman spectrum. Of the twelve theoretical phonon branches in the wurtzite ZnO, nine are optically active (Arguello et al., 1969). Predictable modes of the lattice optical phonons are Γ=1A₁+2B₁+1E₁+2E₂, of which A₁, E₁, and E₂ show Raman activity while B₁ is considered Raman silent. The E₂ modes indicate the level of crystallinity of as-grown ZnO NWs, while A₁ and E₁ correspond with common defects or vacancies. The Raman spectra (FIG. 2E) at representative locations showed high intensity modes for E₂^{low} and E₂^{high} (97.6 cm⁻¹ and 436.9 cm⁻¹) which correlate with the Zn and O₂ sub-lattices, respectively (Alameri et al., 2017; Geng et al., 2004; Cheng et al., 2009; Calzolari & Nardelli, 2013). The strongest peak in the Raman data was the E₂^{high} peak with FWHM ˜10.87 cm⁻¹ which without being bound by theory indicated a high level of crystallinity. Notably, the E₁(TO) and E₁(LO) modes were insignificant in the ZnO NW samples (Calzolari & Nardelli, 2013; Xu et al., 2009). To further confirm the crystal orientation and structural properties of ZnO NWs, high-resolution transmission electron microscopy (HRTEM) and selected area electron diffraction (SAED) were performed. Nickel TEM grids were prepared by scrapping ZnO NWs from a ZnO NWs/CNTs sample onto the grid with the flat-edged tweezers. An HRTEM image shows a crystal lattice spacing of ˜0.532 nm (FIG. 2F); SAED is shown in the inset of FIG. 2F. A Wurtzite crystal structure is observed for the ZnO NWs, and the values are consistent with other reported HRTEM analyses (Xu et al., 2010; Geng et al., 2004).

c. Characterization of Heterostructures

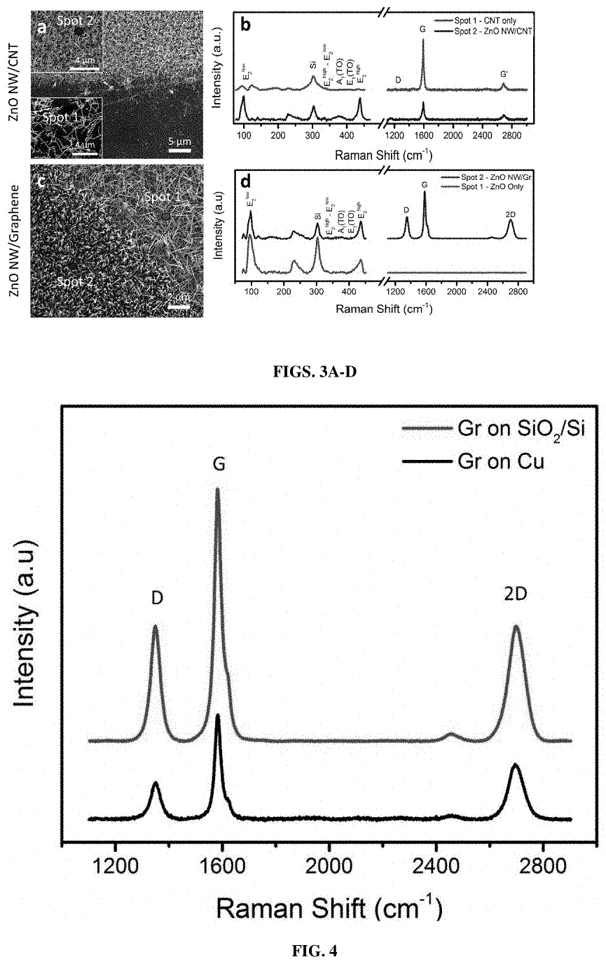

To confirm that the integrity of the material was preserved post-heterostructure formation the samples were further evaluated. The morphology of ZnO NWs/CNTs heterostructure was observed via SEM (FIG. 3A). Insets show dense, vertically aligned ZnO NWs grown on top of CNTs (FIG. 3A, top) and CNTs only (FIG. 3A, bottom). The ZnO NWs/Gr heterostructure, however, (FIG. 3C) showed distinct morphological changes when ZnO NWs were grown on SiO₂/Si (FIG. 3C, upper right corner) substrate versus graphene (FIG. 3C, lower left corner). Without being bound by theory, morphological differences in the ZnO NWs grown on graphene were manifested in greater alignment and density, while the ZnO NWs grown on the SiO₂/Si surface appear identical to the reference samples of ZnO NWs. Again without being bound by any theory, the atomically flat crystal structure of graphene promoted greater alignment in the ZnO NWs grown directly on its surface, and with greater alignment, the density of ZnO NWs was observed to increase. In contrast, while ZnO NWs still grow with vertical tendencies, they did not exhibit strong preferential alignment when grown on amorphous SiO₂ surface and appeared at relatively lower densities. The hydrophobicity of graphene relative to SiO₂/Si decreased catalyst ink spreading during dip-coating, which without being bound by theory, created more dense nucleation points or larger cluster aggregates from which ZnO NWs grew, which in turn led to larger ZnO NW diameters and density of NWs per unit surface area (Alameri et al., 2017).

Additionally, Raman spectroscopy of both heterostructures confirmed that the quality and crystallinity of CNTs, graphene, and ZnO NWs was preserved in the heterostructure interfaces. In FIG. 3B, spot 1 was selected from the region designed to contain only CNTs, so the characteristic E₂^{high} (˜436.9 cm⁻¹) signal for ZnO NWs was negligible, while the G-band (1592 cm⁻¹) was intense and narrow (FWHM of ˜15.9 cm⁻¹) with very few defects (ID/IG ˜0.0149). These results further identified high-quality CNTs even where ZnO NWs did not grow to a complete crystal structure. Conversely, spot 2 was selected from a region where the ZnO NWs/CNTs heterostructure was formed, so the E₂^{high} and E₂^{low} (˜436.9 cm⁻¹ and ˜97.6 cm⁻¹) modes were clearly observed, consistent with the results shown in FIG. 2. Likewise, the CNTs G-band (1593.24 cm⁻¹) was narrow (FWHM ˜26.82 cm⁻¹) with minimal defects (ID/IG ˜0.0192), further confirming the quality of the CNTs was not adversely affected by the growth of the ZnO NWs. The Raman spectra of the ZnO NWs/Gr heterostructure (FIG. 3D) confirmed ZnO NWs were present at both spot 1 and spot 2 of SEM image (FIG. 3C) with intense peaks representing E₂^{high} and E₂^{low} (˜438.9 cm⁻¹ and ˜99.7 cm⁻¹) consistent with the ZnO NWs reference sample in FIG. 2. The characteristic peaks of graphene were present only at spot 2, where the ZnO NWs/Gr heterostructure had formed, but were absent at spot 1. The narrow G-band at 1583 cm⁻¹ (FWHM of ˜28.5 cm⁻¹) indicated the graphene was of high quality and a G-band/2D-band ratio of ˜2.51 confirmed the few-layer nature of the graphene, which was consistent with the Raman spectra of the graphene samples on Cu and SiO₂/Si prior to heterostructure formation (FIG. 4). This characterization confirmed that the integrity of the graphene was not damaged by the ZnO NWs grown on its surface.

d. Energy-Dispersive X-Ray Spectroscopy and Photoluminescence Spectroscopy

Energy-dispersive X-ray spectroscopy (EDS) was performed on both heterostructures and on ZnO NWs reference samples to confirm elemental compositions of the prepared samples. EDS spectra for each material with a representative SEM image are shown in FIGS. 5A-C. All samples had signature peaks for oxygen, zinc, and the Si substrate near 0.5 KeV, 1.1 KeV, and 1.75 KeV, respectively. The high-intensity peaks for zinc and oxygen indicated their presence on the sample surface in the form of ZnO NWs. A Si peak was also observed, typical for samples prepared on SiO₂/Si substrates (Zhu et al., 2012). An additional silicon peak at 0 KeV is naturally present in all spectra (not shown here).

Interestingly, there was no peak representing residual iron for any of the samples, which without being bound by theory indicates that this growth process was primarily based-growth. The catalyst particles were encapsulated by the growing ZnO NWs (Alameri et al., 2017; Zhu et al., 2005; Lim et al., 2016). Specific details on the percent composition of each element can be found in Table 1, which confirmed the presence of Zn, 0, and Si in expected ratios consistent with previous studies (Alameri et al., 2017).

TABLE 1
EDS Composition data for ZnO NWs/Gr and ZnO NWs/CNTs Heterostructures

| | Compound Wt. (%) | | | | Compound Wt. (%) | | | | Compound Wt. (%) | | | |
|---|---|---|---|---|---|---|---|---|---|---|---|---|
| Sample/ | CNT/ZnONW | | | | Graphene/ZnO NW | | | | ZnO NW Reference | | | |
| Element | Spot 1 | Spot 2 | Spot 3 | Average | Spot 1 | Spot 2 | Spot 3 | Average | Spot 1 | Spot 2 | Spot 3 | Average |
| O | 21.49 | 21.64 | 19.15 | 20.76 | 16.24 | 16.49 | 17.70 | 16.81 | 18.77 | 19.78 | 16.95 | 18.50 |
| Si | 56.26 | 53.90 | 35.86 | 48.67 | 31.68 | 32.16 | 49.86 | 37.90 | 29.33 | 32.22 | 32.15 | 31.23 |
| Zn | 22.25 | 24.46 | 44.98 | 30.56 | 52.09 | 51.35 | 32.45 | 45.30 | 51.90 | 48.00 | 50.90 | 50.27 |

Photoluminescence (PL) spectroscopy was also employed to analyze the photoexcitation exhibited by ZnO NWs in the prepared heterostructures. The PL spectra (FIG. 5D) confirmed sharp peaks with full width at half maxima (FWHM ˜0.105 eV). The PL Peaks maxima located at ˜3.3 eV near band-edge range excitonic emission (NBE) at the excitation wavelength ˜276 nm laser light (Alameri et al., 2017).

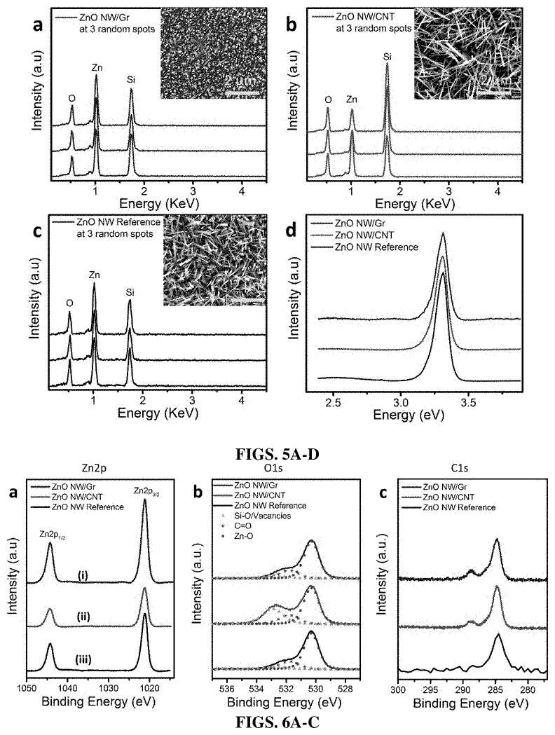

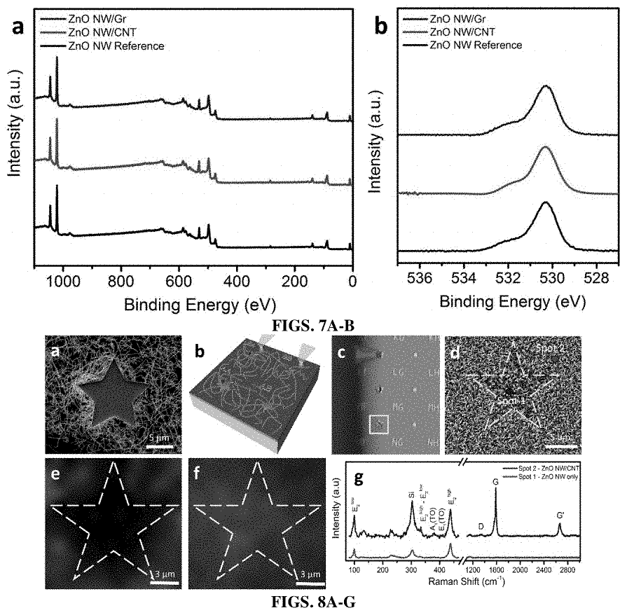

X-ray photoelectron spectroscopy (XPS) was performed to characterize the elemental chemical composition and chemical states of the prepared heterostructures (ZnO NWs/CNTs and ZnO NWs/Gr) and the reference sample (ZnO NWs). FIG. 6A illustrated the core-levels spectra of Zn2p for ZnO NWs samples, ZnO NWs/CNTs, and ZnO NWs/Gr heterostructures, which are indicated by two notable peaks located at ≈1021.4 eV and ≈1044.5 eV representing Zn2p3/2 and Zn2p1/2 in the Zn2+ state, respectively (Alameri et al., 2017). The O1s energy-levels spectra were represented in FIG. 6B, where three distinct peaks (out-lined by the Gaussian fit) were found at ≈530.1 eV, 531.7 eV, and 532.9 eV in all three samples ZnO NWs/CNTs and ZnO NWs/Gr heterostructures and ZnO NWs reference. The peak at lower binding energy (530.1 eV) confirmed the participation of 0-ions with Zn-ions, while without being bound by theory, the other two peaks at higher binding energies (531.7 eV and 532.9 eV) imply to oxygen vacancies/defects absorption with some contribution from Si—O bonding (Lim et al., 2016). It is important to note here that the oxygen defects peak (represented by the higher binding energy ≈532.9 eV) was observed to have a higher intensity in ZnO NWs/CNTs heterostructures than in the reference sample (ZnO NWs/SiO₂/Si) and in ZnO NWs/Gr samples. Without being bound by theory, the intensity of the relatively higher defect in the ZnO NWs/CNTs heterostructure could be due to additional residuals accumulated on the sample surfaces during the two subsequent CVD runs. While subtracting a peak (˜532.9 eV) from all spectra, in FIG. 6B (see FIG. 7B post-subtraction), near-identical spectral plots in all three samples were observed, showing consistency between the sample types outside of their oxygen defect presence.

In contrast, a single CVD run was used to fabricate ZnO NWs reference samples and ZnO NWs/Gr hybrids prepared on cleaner and smoother surfaces of SiO₂/Si and graphene substrates, respectively. FIG. 6C shows the XPS spectral analyses of the C1s corresponding to ZnO NWs (reference sample, black curve). At the same time, ZnO NWs/CNTs (red) and ZnO NWs/Gr (blue) represent heterostructured samples. FIG. 6C clearly shows a sharp peak at ˜284.7 eV, attributed to C═C bonds (Hossain et al., 2016; Sharma et al., 2019). In addition to the prominent peak that was observed in all fabricated specimens, a small hump localized at ≈288.4 eV was observed only in the heterostructured samples; ZnO NWs/CNTs (red) and ZnO NWs/Gr (blue), which was expected due to the presence of C═O bonding (Hossain et al., 2016; Sharma et al., 2019).

e. Localized Heterostructure Formation and Characterization

While growing quality materials and heterostructure interfaces consistently and reproducibly is essential, the ability to grow heterostructure interfaces selectively at desired locations is of great practical importance. A proof-of-concept experiment was conducted to demonstrate ZnO NWs/CNTs heterostructures formed on a SiO₂/Si sample with etched-in silicon features. Etched star shapes geometrical features (trenches) were prepared via optical laser lithography following RIE in SiO₂/Si chips. Details of the lithography and RIE etching are described in the Methods section above.

CNTs were first grown on these samples following dip-coating with CCFe ink (FIG. 8A) and showed to grow densely only outside of the star-shaped features. While this conveyed a well-documented notion of the importance of the SiO₂ in the growth of CNTs, it also allowed for selective exclusion of CNTs from the etched area. Thus, it allowed for morphology control and placement of the ZnO NWs in the next step of the growth as described below (Cao et al., 2004; Simmons et al., 2006). DWP was used to selectively fill star-shaped features with the CCFe catalytic ink (tens-to-hundreds of femtoliters (10⁻¹² L) volumes) using custom AFM cantilevers (FIG. 8B, 8C). Depositing CCFe ink into these star-shaped features increased the effective density of catalytic particles per unit area. Indeed, the diameters of ZnO NWs originating from these features appeared larger—a result which has been observed in ZnO NWs growth using high-density catalyst aggregation (Alameri et al., 2004). Hence, following ZnO NWs CVD growth, ZnO NWs were observed to grow more densely, exhibited greater alignment, and had larger diameters at the locations where additional ink was deposited, as compared to those produced at the neighboring etched features with a lower concentration of the catalyst or on the surrounding substrate surface (FIG. 8D).

FIGS. 8E-8G show Raman spectroscopy and Raman intensity maps of a region surrounding the star-shaped feature. Two spots, inside and outside of the feature shown in FIG. 8D, were analyzed at each respective location; the spectra are shown in FIG. 8G. The Raman spectrum at spot 1 (ZnO NWs only) exhibits strong E₂^{high} and E₂^{low} (438.9 cm⁻¹ and 99.7 cm⁻¹) peaks consistent with the discussion of FIG. 2 for ZnO NWs, while the G-band signal for CNTs was not present. Meanwhile, the Raman spectrum at spot 2 (ZnO NWs/CNTs) exhibited signature peaks of both ZnO NWs and CNTs with minor defects (D-band/G-band ˜0.0191). Thus, Raman mapping of the region containing the feature allowed us, without being bound by any theory, to characterize the quality of materials present on the locations where they grew. Regions colored in red represent the relative intensity of the CNTs G-band (1582 cm⁻¹) and ZnO NWs E₂^{high} mode (440 cm⁻¹) in FIG. 8E and FIG. 8F, respectively. The Raman map in FIG. 8E showed intense G-band signatures selectively outside of the star-shaped feature, which is representative of the CNTs presence.

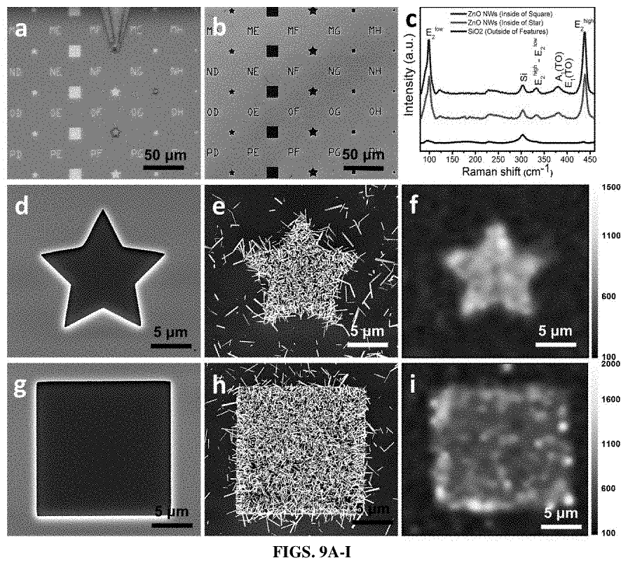

Meanwhile, the Raman map in FIG. 8F showed high-intensity signals for E₂^{high} over the entire region, which is representative of ZnO NWs presence. This map also shows a slightly higher relative intensity of E₂^{high} inside of the star-shaped feature, where a greater alignment and density of ZnO NWs was observed. ZnO NWs were also grown selectively inside of the other etched-in geometrical features on reference SiO₂/Si. As it can be seen in FIG. 9, ZnO NWs only grew in the features where catalytic ink was directly deposited. Without being bound by theory, CNTs grew selectively on the exterior of the feature because the SiO₂ layer is completely removed during the RIE process, leaving bare Si substrate lacking necessary SiO₂, which again without being bound by theory is critical for proliferal growth of CNTs (Cao et al., 2004; Simmons et al., 2006; Jung et al., 2003; Xiang et al., 2010). This example demonstrated flexibility in fabrication (lithography and subsequent CVD growth) of various micro- and nano-architectures. The methods described herein may also be used to design hybrid heterostructures in a selective/predefined fashion, thus providing greater control over material placement, which is paramount for interface and device engineering.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

### REFERENCES

The following references, to the extent that they provide exemplary procedural or other details supplementary to those set forth herein, are specifically incorporated herein by reference:
Ahmed et al., Drug Discov. Today, 17:928-34, 2012.
Alameri et al., Adv. Mater. Interfaces, 4:1700950, 2017.
Alameri et al., J. Vac. Sci. Technol. A, 36:05G506, 2018.
Anand et al., Sens. Actuators B Chem., 195:409-15, 2014.
Arguello et al., Physical Review, 181:1351-63, 1969.
Baughman et al., Science, 297:787-92, 2002.
Bethune et al., Nature, 1993, 363:605-07, 1993.
Bettini et al., J. Phys. Chem. C, 119:20143-49, 2015.
Caglar et al., Appl. Surf Sci., 255:4491-96, 2009.
Calzolari & Nardelli, Sci. Rep., 3:2999, 2013.
Cao et al., Appl. Phys. Lett., 84:109-11, 2004.
Cheng et al., J. Appl. Phys., 105:073104, 2009.
Dong et al., Adv. Mater. Interfaces, 3:1600098, 2016.
Dresselhaus et al., Philos. Trans. Royal Soc., 368:5355-77, 2010.
Fu et al., Appl. Phys. Lett. 100:223114, 2012.
Geng et al., Adv. Funct. Mater., 14:589-94, 2004.
Hanley et al., Nanotechnology, 19:295103, 2008.
Hossain et al., RSC Adv., 6:71450-60, 2016.
Iijima & Ichihashi, Nature, 363:603-05, 1993.
Jorio et al., New J. Phys., 5:139, 2003.
Jung et al., Nano Lett., 3:561-64, 2003.
Keefer et al., Nat. Nanotechnol, 3:434-439, 2008.
Kocaman et al., Surf Coat. Technol., 399:126144, 2020.
Kordzadeh et al., J. Mol. Graph Mod. 88:11-22, 2019.
Kuljanishvili et al., Small, 5:2523-27, 2009.
Lee et al., J. Phys. Chem. C, 113:19134-38, 2009.
Li et al., ACS Nano, 6:5164-73, 2012.
Lim et al., Materials, 9:300, 2016.
Modugno et al., Br. J. Pharmacol, 172:975-91, 2015.
Nourmohammadi et al., J. Alloys Compd., 612:380-85, 2014.
Ok et al., Adv. Funct. Mater., 20:2470-80, 2010.
Pandurangan et al., J. Photochem. Photobiol. B, Biol, 158:206-11, 2016.
Panth et al., ACS Appl. Nano Mater., 3:6711-18, 2020.
Pitkethly, Mater. Today, 7(12):20-29, 2004.
Rasmussen et al., Expert Opin. Drug Deliv., 7:1063-77, 2010.
Ruddaraju et al., Mater. Sci. Eng. C, 103:109756, 2019.
Schwartz et al., Neuron, 52:205-220, 2006.
Sharma et al., Chem. Eng. J., 358:540-51, 2019.
Shrestha et al., Mater. Des., 133:69-81, 2017.
Simmons et al., Small 2:902-09, 2006.
Singh et al., AIP Advances, 3:082106, 2013.
Song et al., IEEE Trans. Nanotechnol., 13:167-71, 2014.
Wang et al., ACS Appl. Mater. Interfaces, 9:39971-84, 2017.
Wongchoosuk et al., J. Phys. Chem. C, 115:757-61 2011.
Xiang et al., Jpn. J. Appl. Phys., 49:02BA03, 2010.
Xie et al., Front. Neuroeng, 7:00034, 2014.
Xie, J et al., Appl. Phys. Lett. 102:193101, 2013.
Xu et al., ACS Appl. Mater. Interfaces, 7:20264-71, 2015.
Xu et al., Nano Res., 3:271-80, 2010.
Zhang et al., Acc. Chem. Res, 46:2329-39, 2013.
Zhao et al., J. Alloys Compd, 708:500-07, 2017.
Zhu et al., Adv. Mater., 18:587-92, 2006.
Zhu et al., Chem. Mater., 17:4227-34, 2005.
Zhu et al., Nanotechnology, 23:055604, 2012.

1. A method of preparing a heterostructure of a carbon-based structure and a metal oxide structure comprising:
(A) exposing a carbon-based structure to an iron-based ink to obtain a heterostructure precursor composition; and
(B) transforming the heterostructure precursor composition in the presence of a metal oxide precursor into a heterostructure of a carbon-based structure and a metal oxide structure.

2. The method of claim 1, wherein the carbon-based structure is graphene or a carbon nanotube.

3.-4. (canceled)

5. The method of claim 1, wherein the metal oxide structure is a metal(II) oxide structure.

6. (canceled)

7. The method of claim 1, wherein the iron-based ink comprises an iron salt in an iron solution.

8.-10. (canceled)

11. The method of claim 1, wherein the iron-based ink further comprises a first solvent.

12.-13. (canceled)

14. The method of claim 1, wherein the iron-based ink further comprises a second solvent.

15.-17. (canceled)

18. The method of claim 1, wherein the iron-based ink comprises a volume ratio of the iron solution to the first solvent from about 1:2 to about 4:1.

19.-20. (canceled)

21. The method of claim 1, wherein the iron-based ink comprises a volume ratio of the iron solution to the second solvent from about 1:1 to about 6:1.

22.-26. (canceled)

27. The method of claim 1, wherein the iron-based ink is deposited on a carbon-based structure in a pattern.

28.-31. (canceled)

32. The method of claim 1, wherein the transformation is done at an elevated temperature zone.

33.-40. (canceled)

41. The method of claim 1, wherein the transformation occurs in a double tube system.

42. The method of claim 41, wherein the double tube system comprises an inner tube and an outer tube wherein the outer tube is configured with a gas inlet.

43.-49. (canceled)

50. The method of claim 1, wherein the metal oxide precursor is located at the open end of the inner tube.

51. The method of claim 1, wherein the metal oxide precursor is located from about 1 cm to about 15 cm to the open end of the inner tube.

52.-53. (canceled)

54. The method of claim 1, wherein the transformation occurs via increasing temperature under an inert gas.

55. The method according to any one of claims 1-54, wherein the transformation comprises purging with an inert gas.

56. The method according to any one of claims 1-55, wherein the metal oxide precurcor is location in the elevated temperature zone.

57. The method according to any one of claims 1-56, wherein the heterostructure precursor composition is located in the second elevated temperature zone.

58. The method of claim 1, wherein the transformation comprises heating for a time period from about 15 minutes to about 300 minutes.

59.-61. (canceled)

62. The method claim 1, wherein the method comprises purging with an inert gas at a purging flow rate from about 100 sccm to about 1,000 sccm.

63.-65. (canceled)

66. The method of claim 1, wherein the method comprises a constant flow of an inert gas during the transformation at a rate from about 10 sccm to about 200 sccm.

67.-77. (canceled)

78. A heterostructure comprising a carbon-based structure and a metal oxide structure prepared according to the methods of claim 1.

79. A device comprising a heterostructure of claim 78.
